(19) United States
(12) Patent Application Publication
(10) Pub. No.: US 2010/0027146 A1
(43) Pub. Date: Feb. 4, 2010

(54) METHOD FOR MANUFACTURING COLOR FILTER AND COLOR FILTER MANUFACTURED BY THE SAME

(76) Inventors: Hyun-Sik Kim, Daejeon Metropolitan City (KR); Bu-Gon Shin, Daejeon Metropolitan City (KR); Hyun-Woo Shin, Gyeonggi-do (KR); Joon-Hyung Kim, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/312,927

(22) PCT Filed: Dec. 6, 2007
(86) PCT No.: PCT/KR2007/006306

§ 371 Date: Jun. 1, 2009

(30) Foreign Application Priority Data
Dec. 6, 2006 (KR) 1020060123076

(51) Int. Cl. G02B 5/22; G02B 1/12

(52) U.S. Cl. 359/891; 264/1.37

(57) ABSTRACT

The present invention relates to a method of manufacturing a color filter, which includes forming a light-shielding portion and a pixel portion on a substrate, and reforming the pixel portion to be ink-philic by using a laser ablation. In the method of manufacturing the color filter, the laser ablation is used to prevent ink particles from being agglomerated in the pixel portion, uniformly filling with the ink, and selectively performing surface reformation of the pixel portion. The color filter manufactured by using the method has desirable pixels without color mixing.

### TECHNICAL FIELD

The present invention relates to a method of manufacturing a color filter and a color filter manufactured by using the same. More particularly, the present invention relates to a method of manufacturing a color filter, which includes uniformly filling in a pixel portion with ink by using a laser ablation, and a color filter manufactured by using the same.

This application claims priority from Korean Patent Application No. 10-2006-0123076 filed on Dec. 6, 2006 in the KIPO, the disclosure of which is incorporated herein by reference in its entirety.

### BACKGROUND ART

In general, a color filter of a liquid crystal display (LCD) has been manufactured by a photolithography process, which requires a great amount of material and very complicated. Therefore, recently an inkjet printing process has been proposed as a substitute for the photolithography process.

The inkjet printing process is simple and a direct spraying type in which a material is jetted on a desired portion to prevent the material from being wasted and it is un-necessary to use a mask. A method of manufacturing a color filter by the inkjet printing process includes forming a light-shielding portion made of a black matrix (BM) which is a resin component by a known photolithography process, and jetting R, G, and B inks on pixel portion between BM, wherein the light-shielding portion is a pattern used as a partition, by the inkjet printing process. This is illustrated in FIG. 1.

In the method of manufacturing the color filter by the inkjet printing process, the light-shielding portion which is a pattern acts as the partition that prevents the occurrence of color nixing between different types of ink jetted on the pixel portions. Therefore, it is preferable that the light-shielding portion be having ink repellency, so that a contact angle to ink is high and ink is prevented from overflowing the partition. However, it is preferable that the pixel portion have ink-philicity so that ink jetted on the pixel portion is uniformly spread on the surface of the pixel portion and that the unfilling and the discoloration do not occur.

However, if the light-shielding portion is manufactured by using the known photolithography process coating the entire surface of the substrate, the substance of the light-shielding portion, which is ink repellent, is adsorbed on the pixel portion. Therefore, the spreadability of ink which is jetted on the pixel portion is reduced, resulting in the unfilling of ink in the pixel portion. This is illustrated in FIG. 3.

In order to avoid the problems, it is suggested that the method include forming a light-shielding film by a known photolithography process and performing additional treatment on the surface of the light-shielding film and a pixel portion so that the pixel portion maintain an ink-philicity.

For example, Japanese Patent Application Publication No. 1997-203803 discloses a method of performing treatment on surface of concave by using an ink-philic treatment agent and on surface of convex by using an ink repellent treatment agent. However, this method is problematic in that the ink-philic treatment process and the ink repellent treatment process should be performed twice separately. In addition, since the surface treatment process affects the light-shielding portion as well as the pixel portion, an aditional process is required to reform only the pixel portion.

Furthermore, Korean Patent Application Publication No. 2000-0047958 discloses a color filter which has a wettability-variable layer capable of changing the wettability, and a method of manufacturing the color filter. However, the method is disadvantageous in that the wettability-variable layer is provided in addition to a partition layer which is a light shielding part and an ink layer which is an opening part to increase the thickness of the color filter and the number of processes forming pattern, thus complicated.

Meanwhile, it is also suggested that a method of patterning a light-shielding portion by using a laser instead of the photolithography process, since a pixel portion is to be ink repellent due to the ink repellent component of the light-shielding portion manufactured by using the photolithography process.

For example, Japanese Patent Application Publication No. 1994-118217 discloses a method of forming a pixel, which includes layering a light shielding layer constituting a light-shielding portion and an ink repellent layer having an water repellency, and irradiating a laser to remove a predetermined portion of the light shielding layer and the ink repellency layer, and filling an opening part with ink.

In addition, Japanese Patent Application Publication No. 1996-292313 discloses a method of irradiating a laser on a rear side which a light-shielding portion is formed in order to prevent the removed laminate substance from being attached to a substrate again. However, the method is disadvantageous in that even though the substance is removed into relatively large particles, the substance is not completely removed from an opening part and is adsorbed on the light-shielding portion again to prevent the laser from being irradiated on a rear side, thus obstructing formation of a desirable pattern. This is illustrated in FIG. 5, and from FIG. 5, it can be seen that the undesirable light-shielding portion on which impurities are adsorbed is formed. Furthermore, there are two layers of the light shielding layer and the water repellent layer, thus it is necessary to perform an additional process.

However, in the above-mentioned methods, since all the impurities are removed by using a laser, high energy is required as compared to the photolithography process. Furthermore, the removed substance is reattached to the substrate again, thus it is difficult to make high-quality products.

Meanwhile, Japanese Patent Application Publication No. 2002-243927 discloses a method of removing a black film from light shielding layer by using laser trimming and forming a black matrix. However, in the method, high energy is required so as to remove a target substance and it is necessary to provide an additional device for inhaling the substance removed by a laser, thus the method is complicated.

### DISCLOSURE OF INVENTION

### Technical Problem

Therefore, in order to solve the above problems, an object of the present invention is to provide a method of manufacturing a color filter and a color filter manufactured by the method. In the method of manufacturing the color filter by an inkjet process, a pixel portion is reformed to be ink-philic by using laser ablation, thus improving spreadability and uniformity of ink.

### Technical Solution

In order to accomplish the above object, the present invention provides a method of manufacturing a color filter, which includes (a) forming a light-shielding portion and a pixel portion on a substrate, and (b) reforming the pixel portion to be ink-philic by using a laser ablation.

Additionally, the present invention provides a color filter which is manufactured by using the method of manufacturing the color filter.

Furthermore, the present invention provides a display device that includes the color filter.

### Advantageous Effects

In a method of manufacturing a color filter according to the present invention, a pixel portion of a color filter can be reformed to be ink-philic without an additional process or a complicated surface treatment process used so as to maintain the ink-philicity. The method is simplified, thus manufacturing cost is reduced. Therefore, the color filter can be manufactured to have no stain and a uniform surface without color mixing, discoloration, and unfilling during filling the pixel portion with ink.

### BRIEF DESCRIPTION OF THE DRAWINGS

FIG. 1 is a view illustrating process manufacturing a color filter by using an inkjet;

FIG. 2 is a sectional view of a substrate that is provided with a light-shielding portion including a black matrix and a pixel portion thereon;

FIG. 3 is a picture illustrating the pixel portion that is undesirably filled with ink;

FIG. 4 is a picture illustrating a pixel portion that is uniformly filled with ink in a color filter manufactured by using a method of manufacturing the color filter according to the present invention; and

FIG. 5 is a picture of a known color filter that is provided with a light-shielding portion on which a substance of a pixel portion removed by a laser is adsorbed.

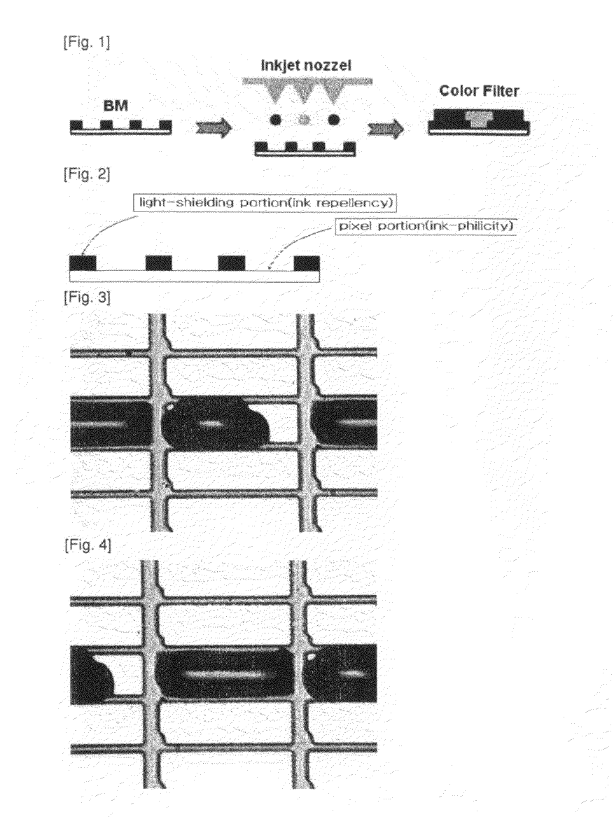

### BEST MODE FOR CARRYING OUT THE INVENTION

Hereinafter, the present invention will be described in detail.

A method of manufacturing a color filter according to the present invention includes (a) forming a light-shielding portion and a pixel portion on a substrate, and (b) reforming the pixel portion to be ink-philic by using a laser ablation.

In the present invention, a light-shielding portion pattern may be formed by a photolithography process. If the light-shielding portion pattern, which is used as a partition, is manufactured by the photolithography process, impurities are removed from the pixel portion region by using low energy, thus forming the desirable light-shielding portion pattern.

Specifically, the photolithography process includes applying the light-shielding material on the substrate, and prebaking, UV exposing, developing, and postbaking the resulting substrate. That is, the photolithography process includes steps of applying the light-shielding material on the substrate, prebaking the light-shielding material, and selectively UV exposing and developing the prebaked light-shielding material. The process further includes a step of performing postbaking. The steps may be performed by using materials known in the related art under a condition known in the related art.

The light-shielding portion, as the partition, including the black matrix made of a resin component is manufactured on the substrate by the photolithography process. The width of the pixel portion which is patterned by the light-shielding portion is preferably the same as a size of a typical LCD and more preferably in the range of 50 to 300 μm.

Additionally, in the present invention, the light-shielding portion, as the partition, including a black matrix and a pixel portion may be manufactured by using an inkjet printing.

In the present invention, examples of the substrate ray include a glass substrate, a plastic substrate, etc. It is preferable to use the glass substrate.

In the present invention, the light-shielding portion is used as the partition and required to be ink repellent in order to prevent the ink jetted on the pixel portion from being mixed with the ink adjacent to the pixel portion.

It is preferable that the light-shielding portion be made of a light-shielding composition which includes 5 to 45% by weight of the solid, 50 to 90% by weight of the solvent, and 0.5 to 5% by weight of an initiator. Furthermore, it is preferable that the solid further include the ink repellent material. Examples of the ink repellent material include a silicone surfactant, a fluorine surfactant, or a mixture thereof. Preferably, they are included in an amount of 0.01 to 0.3 parts by weight based on 100 parts by weight of the solid.

In addition, the solid further includes 20 to 50 parts by weight of any one selected from the group consisting of a carbon black coloring agent, a organic pigment mixed type light shielding coloring agent, and a hybrid type coloring agent containing the carbon black and the organic pigment mixed type light shielding coloring agent mixed with each other, 20 to 50 parts by weight of a binder polymer component, and 20 to 40 parts by weight of a crosslinking agent based on 100 parts by weight of the solid.

Meanwhile, it is required that the ink is uniformly filled on the pixel portion without the unfilling. Accordingly, it is preferable that the pixel portion is to be ink-philic.

In order to reform the pixel portion to be ink-philic, the laser ablation according to the present invention may be performed only on the pixel portion or on the entire side of the substrate which includes the pixel portion and the light-shielding portion. In addition, the laser ablation according to the present invention may be performed on the front side, which the light-shielding portion is formed, of the substrate, or on the rear side, which the light-shielding portion is not formed, of the substrate in order to reform the pixel portion to be ink-philic.

In connection with this, in the case of when the laser is irradiated on the front side of the substrate, the laser can be selectively irradiated only on the pixel portion or on the entire surface of the substrate including the pixel portion and the light-shielding portion. To be more specific, only the pixel portion is selectively subjected to the laser ablation excluding the light-shielding portion to remove the adsorption substance from the pixel portion, thereby reforming the pixel portion to be ink-philic. Additionally, even if the laser is irradiated on the entire side of the substrate which includes the light-shielding portion, only an upper part of the light-shielding portion is removed with the adsorption substance of the pixel portion. Accordingly, the pixel portion can be reformed to be ink-philic while the reformation does not affect the light-shielding portion. Furthermore, since the laser can be irradiated on the wide area at a time, the time that is required to perform the laser ablation can be reduced.

In the case of when the laser is irradiated on the rear side of the substrate, the laser may be irradiated on an adhesion portion of the light-shielding portion and glass to reduce adhesive strength according to the intensity of the laser. Therefore, it is required that the intensity of the laser is controlled.

In the method of manufacturing the color filter according to the present invention, the light-shielding portion is first manufactured on the substrate to form the pixel portion, and the laser ablation is performed to reform the pixel portion to be ink-philic. If the color filter is manufactured by using a known method that includes applying a light-shielding material on a substrate, and forming a pixel portion by removing partially the light-shielding material by performing only laser ablation without forming a light-shielding portion, high energy is required, and the removed material is reattached to the substrate. Therefore, the pixel portion cannot be completely reformed to be ink-philic and the resulting pixel portion cannot be clean.

Specifically, examples of the laser which is used to perform the laser ablation according to the present invention include an ND:YAG laser, a KrF excimer laser, a He-Cd laser, etc. having a wavelength in the range of 355 to 248 nm. By using the above-mentioned laser under a condition of 5 to 100 kHz, 50 to 100% power, and 0.01 to 10 m/sec, the residual adsorption substance, which is ink repellent, can be removed from the pixel portion. In connection with this, it is preferable that the scan width of the laser be in the range of 10 to 100 μm. However, the scan width of the laser may be changed if necessary.

Unlike the published patents, in the method of manufacturing the color filter according to present invention, only the adsorption substance is removed from the pixel portion since the substance of the light-shielding portion is already removed from the pixel portion by the photolithography process. Accordingly, energy is minimally required, the pixel portion is not affected by the light-shielding material, and there is no residual substance regardless of the irradiation direction of the laser. Therefore, it is unnecessary to use an additional inhalator for inhaling the residual substance, and the intensity and the scan width of laser can be controlled to adjust the spreadability of ink. By the above-mentioned procedure, the light-shielding portion is reformed to be ink repellent and the pixel portion is reformed to be ink-philic.

After the laser ablation is performed under the above-mentioned condition, the ink is jetted on the ink-philic pixel portion by the inkjet process. The jetting of ink by the inkjet process ray be performed in such a way that at least two types of ink are simultaneously or successively jetted on the pixel portion which is reformed to be the ink-philic by using the laser ablation. The inkjet process is a direct pattern type which the jetting the ink is selectively performed on only a required portion. Accordingly, the ink can be filled on only the pixel portion, excluding the light-shielding portion.

Since the pixel portion which is subjected to the laser ablation has the ink-philicity, the ink which is filled on the pixel portion is uniformly spread on the pixel portion, thus forming a uniform ink film without unfilling. Meanwhile, the light-shielding portion which is ink repellent prevents the ink which is jetted on the pixel portion from overflowing the light-shielding portion, thus the pixel portion can have convex surface which is higher than the light-shielding portion. In addition, the light-shielding portion functions to prevent the occurrence of color mixing between ink on the pixel portion and ink on the adjacent pixel portion, thus forming the desirable pixel portion.

In connection with this, both photo-curable ink and heat-curable ink may be used. Finally, the post-treatment processe may be performed simultaneously to manufacture the color filter. The post-treatment processe includes curing the jetted ink. In the case of when the color filter is manufactured by a known method, various types of ink are jetted. In connection with this, every time different types of ink are jetted, the different curing processes are separately performed in order to prevent the occurrence of color mixing between the different types of ink on the adjacent pixel portions. Therefore, the number of processes is increased.

However, in the case of the present invention, every time different types of ink are jetted, the different curing processes may be separately performed, or the single curing process may be performed in respects to all types of ink at a final stage after all types of ink are jetted, because the light-shielding portion functions to prevent the color mixing. Therefore, the method according to the present invention is simple. In connection with this, in the case of the photo-curable ink, the curing process includes a heat treatment process and a UV irradiation process. In the case of the heat-curable ink, a single-stage heat treatment process or a two-stage heat treatment process is performed. The heat treatment process is typically performed at 50 to 250° C for. 10 sec to 200 min, and the UV irradiation is performed in the intensity of 80 to 200 mV/cm² for 5 to 500 sec.

The present invention provides a color filter which is manufactured by using the method of manufacturing the color filter. In the color filter manufactured like the method, the color mixing, the discoloration, the unfilling, and the staining do not occur, and the uniform surface is ensured.

In addition, the present invention provides a display device which includes the color filter.

Hereinafter, the present invention will be described in detail in light of Examples. The present invention may, however, be embodied in many different forms and should not be construed as being limited to the Examples set forth herein. Rather, these Examples are provided such that this disclosure will be thorough and complete and will fully convey the concept of the present invention to those skilled in the art.

### MODE FOR THE INVENTION

### <Example 1>

The light-shielding portion, which is the black matrix partitions made of resin components, was manufactured on the glass substrate by using a photolithography process. The pixel portion which was patterned by using the light-shielding portion had a size of about 200 μm×600 μm. The scanning was performed in respects to the front side of the substrate by using an ND:YAG laser having a wavelength of 355 nm under the condition of 40 kHz, 60% power, and 0.1 m/sec to remove the residual adsorption substance, which is ink repellence from the pixel portion. In connection with this, the scan width of the laser was in the range of 20 to 30 μm. Ink was jetted on the ink-philic pixel portion after the laser ablation was performed by using the inkjet process. FIG. 4 is a picture illustrating that ink is jetted without the unfilling.

### <Comparative Example 1>

The procedure of Example 1 was repeated except that the laser ablation process was not performed. From a picture of FIG. 3, it can be seen that the unfilling occurs.

### <Comparative Example 2>

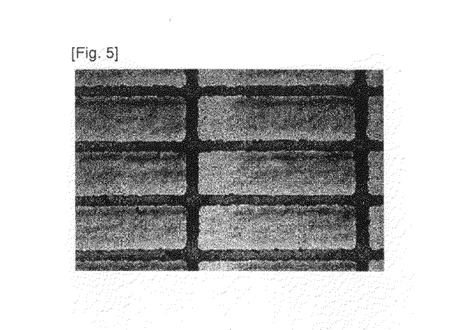

The ink repellent material was applied on the glass substrate and then cured while the light-shielding portion was not patterned on the glass substrate by using the photolithography process. Next, the material in the pixel portion region was removed only by using the laser ablation without an additional absorption device for absorbing the material to separate the light-shielding portion and the pixel portion from each other. From FIG. 5, it can be seen that desirable patterns are not formed. In the present invention, the pictures of the color filters were taken by using a black-and-white CCD camera at 50× magnification.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of manufacturing a color filter, comprising the steps of:
(a) forming a light-shielding portion and a pixel portion on a substrate; and
(b) reforming the pixel portion to be ink-philic by a laser ablation.

2. The method of manufacturing a color filter according to claim 1, wherein the step (b) comprises:
irradiating a laser on a front side or a rear side of the substrate.

3. The method of manufacturing a color filter according to claim 1, wherein the step (a) comprises:
(a1) applying a light-shielding material on the substrate;
(a2) prebaking the light-shielding material; and
(a3) selectively exposing and developing the prebaked light-shielding material.

4. The method of manufacturing a color filter according to claim 3, wherein the step (a) further comprises:
(a4) performing postbake.

5. The method of manufacturing a color filter according to claim 1, wherein material of the substrate comprises glass or plastic.

6. The method of manufacturing a color filter according to claim 1, wherein the light-shielding portion is made of a composition that comprises 5 to 45% by weight of a solid, 50 to 90% by weight of a solvent, and 0.5 to 5% by weight of an initiator.

7. The method of manufacturing a color filter according to claim 6, wherein the composition comprises ink repellent material.

8. The method of manufacturing a color filter according to claim 7, wherein the ink repellent material comprises 0.01 to 0.3 parts by weight of a silicone surfactant, a fluorine surfactant, or a mixture thereof based on 100 parts by weight of the solid.

9. The method of manufacturing a color filter according to claim 8, wherein the solid comprises 20 to 50 parts by weight of any one selected from the group consisting of a carbon black coloring agent, an organic pigment mixed type light-shielding coloring agent, and a hybrid type coloring agent containing the carbon black and the organic pigment mixed type light-shielding coloring agent mixed with each other, 20 to 50 parts by weight of a binder polymer component, and 20 to 40 parts by weight of a crosslinking agent based on 100 parts by weight of the solid.

10. The method of manufacturing a color filter according to claim 1, wherein the step (b) comprises:
only the pixel portion is irradiated by the laser ablation

11. The method of manufacturing a color filter according to claim 1, wherein the step (b) comprises:
entire substrate comprising the pixel portion is irradiated by the laser ablation.

12. The method of manufacturing a color filter according to claim 1, further comprising:
simultaneously or successively filling with at least two types of ink.

13. The method of manufacturing a color filter according to claim 12, wherein the filling of at least two types of ink is performed by an inkjet process.

14. A color filter manufactured by the method of claim 1.

15. A display device comprising the color filter of claim 14.
